(19) United States
(12) Patent Application Publication
(10) Pub. No.: US 2026/0088432 A1
(43) Pub. Date: Mar. 26, 2026

(54) THERMAL BARRIER INTEGRATED SENSING COVER ASSEMBLIES FOR TRACTION BATTERY ARRAYS

(71) Applicant: FORD GLOBAL TECHNOLOGIES, LLC, Dearborn, MI (US)

(72) Inventors: Alexey Konstantinov, Dearborn, MI (US); Daniel Paul Roberts, Livonia, MI (US); Daryl Arnell Marlow, Dearborn, MI (US); Francisco Fernandez-Galindo, Canton, MI (US)

(21) Appl. No.: 18/892,993

(22) Filed: Sep. 23, 2024

(51) Int. Cl. H01M 50/287; B60L 50/64; H01M 10/0525; H01M 10/48; H01M 10/658; H01M 50/211; H01M 50/271; H01M 50/507

(52) U.S. Cl. CPC H01M 50/287; B60L 50/64; H01M 10/0525; H01M 10/482; H01M 10/658; H01M 50/211; H01M 50/271; H01M 50/507; H01M 2220/20

(57) ABSTRACT

Battery arrays are provided for traction battery packs. An exemplary battery array may include a sensing cover assembly having integrated thermal barriers. Each thermal barrier may be secured to a top cover of the sensing cover assembly using a combination of one or more top cover slots and one or more thermal barrier tabs, thereby reducing parts and complexity.

### TECHNICAL FIELD

This disclosure relates generally to traction battery packs, and more particularly to battery arrays that include sensing cover assemblies having integrated thermal barriers.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, a plurality of battery cells, and a busbar module assembly configured to electrically connect the plurality of battery cells. The busbar module assembly includes a first busbar module, a second busbar module, and a sensing cover assembly connected to the first busbar module and the second busbar module. The sensing cover assembly includes a plurality of integrated thermal barriers.

In a further non-limiting embodiment of the foregoing battery array, the plurality of integrated thermal barriers are secured to a top cover of the sensing cover assembly.

In a further non-limiting embodiment of either of the foregoing battery arrays, the sensing cover assembly further includes a flexible printed circuit board.

In a further non-limiting embodiment of any of the foregoing battery arrays, the sensing cover assembly further includes a foam barrier disposed between the top cover and the flexible printed circuit board.

In a further non-limiting embodiment of any of the foregoing battery arrays, a first thermal barrier of the plurality of integrated thermal barriers includes a tab received within a slot of the top cover to secure the first thermal barrier to the top cover.

In a further non-limiting embodiment of any of the foregoing battery arrays, a first thermal barrier of the plurality of integrated thermal barriers includes a plurality of tabs received within a plurality of slots of the top cover to secure the first thermal barrier to the top cover.

In a further non-limiting embodiment of any of the foregoing battery arrays, the plurality of integrated thermal barriers are made of a thermally resistant material, and the top cover is made of a plastic material.

In a further non-limiting embodiment of any of the foregoing battery arrays, a top cover of the sensing cover assembly includes a first mount received through a first opening of the first busbar module and a second mount received through a second opening of the second busbar module.

In a further non-limiting embodiment of any of the foregoing battery arrays, a frame of each of the first busbar module and the second busbar module includes an opening sized to receive a cell tab terminal of at least one battery cell of the plurality of battery cells.

In a further non-limiting embodiment of any of the foregoing battery arrays, a busbar is mounted to the frame.

A battery array for a traction battery pack according to another exemplary aspect of the present disclosure includes, among other things, a cell stack assembly including plurality of battery cells and a busbar module assembly. The busbar module assembly includes a sensing cover assembly that includes a top cover and a first thermal barrier secured to the top cover.

In a further non-limiting embodiment of the foregoing battery array, the sensing cover assembly further includes a flexible printed circuit board.

In a further non-limiting embodiment of either of the foregoing battery arrays, the sensing cover assembly further includes a foam barrier disposed between the top cover and the flexible printed circuit board.

In a further non-limiting embodiment of any of the foregoing battery arrays, the sensing cover assembly is connected to a first busbar module and a second busbar module of the busbar module assembly.

In a further non-limiting embodiment of any of the foregoing battery arrays, the top cover of the sensing cover assembly includes a first mount received through a first opening of the first busbar module and a second mount received through a second opening of the second busbar module.

In a further non-limiting embodiment of any of the foregoing battery arrays, the first thermal barrier includes a first tab received within a first slot of the top cover to secure the first thermal barrier to the top cover.

In a further non-limiting embodiment of any of the foregoing battery arrays, a second thermal barrier of the sensing cover assembly includes a second tab received within a second slot of the top cover to secure the second thermal barrier to the top cover.

In a further non-limiting embodiment of any of the foregoing battery arrays, a third thermal barrier of the sensing cover assembly includes a third tab received within a third slot of the top cover to secure the third thermal barrier to the top cover.

In a further non-limiting embodiment of any of the foregoing battery arrays, the first thermal barrier of the sensing cover assembly includes a plurality of tabs received within a plurality of slots of the top cover to secure the first thermal barrier to the top cover.

In a further non-limiting embodiment of any of the foregoing battery arrays, the first thermal barrier is made of a thermally resistant material, and the top cover is made of a plastic material.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack.

FIG. 3 is a partial exploded view of a cell stack assembly of the battery array of FIG. 2.

FIG. 4 illustrates a sensing cover assembly of a battery array.

FIG. 5 is a cross-sectional view through section 5-5 of FIG. 4.

FIG. 6 illustrates a top cover of the sensing cover assembly of FIGS. 4-5.

FIG. 7 illustrates another exemplary sensing cover assembly of a battery array.

### DETAILED DESCRIPTION

This disclosure details battery arrays for traction battery packs. An exemplary battery array may include sensing cover assembly having integrated thermal barriers. Each thermal barrier may be secured to a top cover of the sensing cover assembly using a combination of one or more top cover slots and one or more thermal barrier tabs, thereby reducing parts and complexity. These and other features are discussed in greater detail in the following paragraphs of this detailed description.

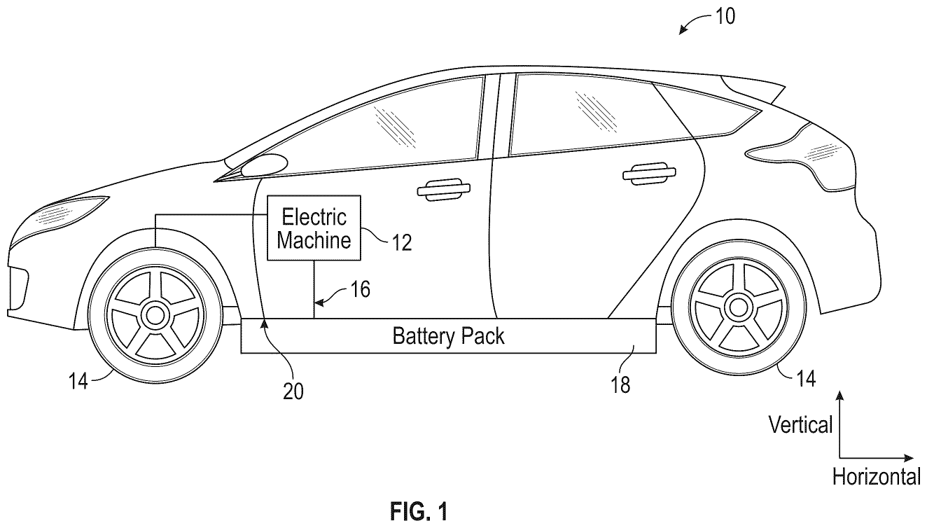

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

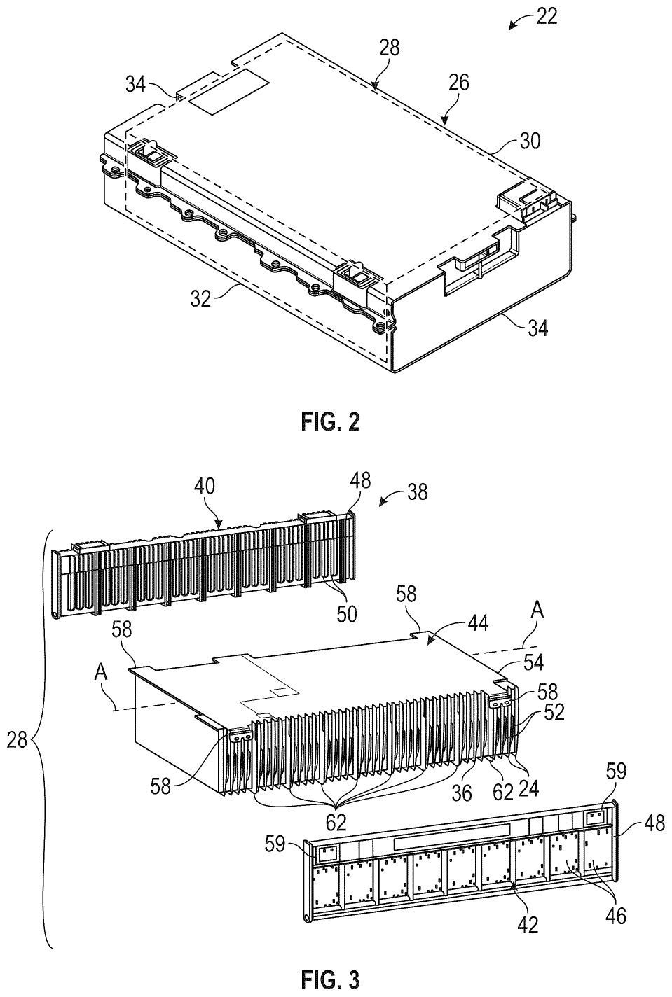

FIGS. 2 and 3 illustrate features associated with an exemplary battery array 22 for use within a traction battery pack, such as the traction battery pack 18 of the electrified vehicle 10 of FIG. 1, for example. One or more battery arrays having a design similar to the battery array 22 could be packaged within the traction battery pack 18.

The battery array 22 may include one or more cell stack assemblies 28 housed within an array housing 26. The array housing 26 may include a top cover 30, a bottom cover 32, and a pair of end plates 34. The top cover 30 may be positioned vertically above the bottom cover 32. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The top cover 30 may be secured (e.g., bolted, welded, adhered, etc.) to the bottom cover 32. Moreover, the top cover 30 and/or the bottom cover 32 may be secured (e.g., bolted, welded, adhered, etc.) to the end plates 34. The top cover 30, the bottom cover 32, and the end plates 34 can be arranged together to provide a sealed enclosure for housing the cell stack assembly 28. However, other array housing 26 configurations are contemplated within the scope of this disclosure. Accordingly, the size, shape, and configuration of the array housing 26 could vary within the scope of this disclosure.

Each cell stack assembly 28 may include a plurality of battery cells 24 arranged together along a cell stack axis A (see FIG. 3). In an embodiment, the battery cells 24 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 24 provided within the battery array 22 may vary and is not intended to limit this disclosure.

A cell expansion pad 36 may be arranged between neighboring battery cells 24 of the cell stack assembly 28. The cell expansion pads 36 may include a material(s) (e.g., polyurethane foam, silicone foam, etc.) adapted for accommodating battery cell swelling.

The cell stack assembly 28 may additionally include a busbar module assembly 38 that is configured to electrically connect the battery cells 24 of the cell stack assembly 28. Once electrically coupled together, the battery cells 24 may supply at least a portion of the electrical power necessary for achieving electric propulsion of the electrified vehicle 10.

The busbar module assembly 38 may include a first busbar module 40, a second bus bar module 42, and a sensing cover assembly 44. The first busbar module 40 and the second busbar module 42 may each include a plurality of busbars 46 held within a busbar frame 48. The total number of busbars 46 provided within each of the first busbar module 40 and the second busbar module 42 is not intended to limit this disclosure.

The busbars 46 may be metallic components of the first and second busbar modules 40, 42, and the busbar frames 48 may be plastic components of the first and second busbar modules 40, 42. In an embodiment, the busbars 46 are made of copper or aluminum, and the busbar frames 48 are made of polypropylene or polyethylene. However, other materials are contemplated within the scope of this disclosure.

Each busbar frame 48 may include openings 50 (e.g., elongated slots) that are each sized for receiving a cell tab terminal 52 of one or more of the battery cells 24 of the cell stack assembly 28. The cell tab terminals 52 may extend through the openings 50 for connection to the busbars 46. The busbars 46 may join together the tab terminals 52 of adjacent battery cells 24 for electrically connecting the battery cells 24 of the cell stack assembly 28.

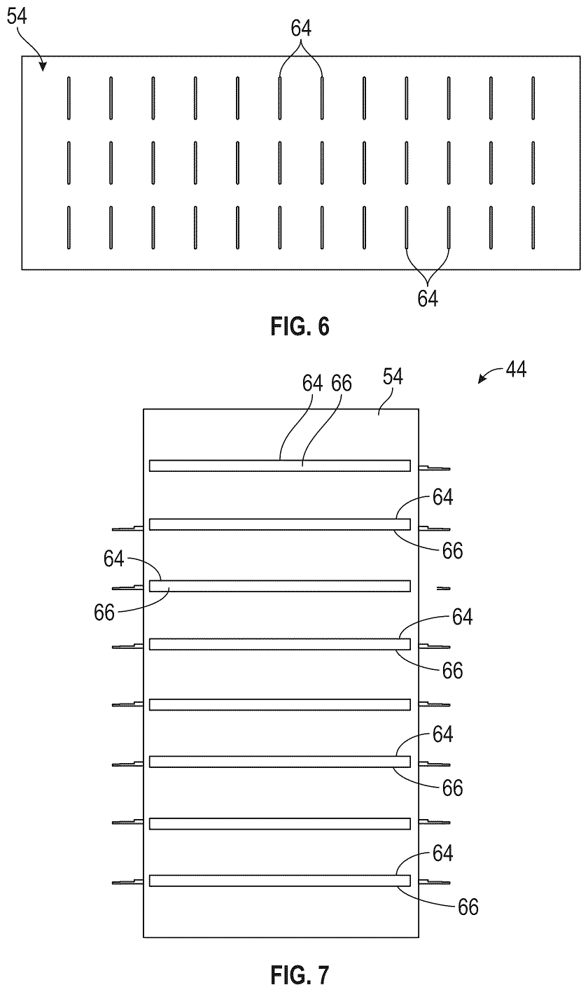

Referring now primarily to FIGS. 3-6, the sensing cover assembly 44 of the busbar module assembly 38 may include a top cover 54, a flexible printed circuit board 56, and a foam barrier 60 disposed between the top cover 54 and the flexible printed circuit board 56. The top cover 54 may be made of any suitable plastic material. The flexible printed circuit board 56 may include sense leads and other circuitry necessary for monitoring voltage and temperature information associated with the battery cells 24 of the cell stack assembly 28. The foam barrier 60 may be secured to or integrally formed with an underside of the top cover 54 and may be configured to protect various circuitry of the flexible printed circuit board 56.

Each opposing side of the top cover 54 may include one or more mounts 58. The first busbar module 40 and the second bus bar module 42 may be secured to the sensing cover assembly 44 via the mounts 58 in order to assemble the busbar module assembly 38. In an embodiment, each mount 58 is received within an opening 59 (see FIG. 3) formed in either the first busbar module 40 or the second busbar module 42. However, other configurations are contemplated within the scope of this disclosure for securing the busbar modules 40, 42 to the sensing cover assembly 44.

The sensing cover assembly 44 may additionally include a plurality of thermal barriers 62. The thermal barriers 62 and the top cover 54 may be integrated together to reduce parts and provide an optimized packaging configuration of the battery array 22. In this disclosure, the term “integrated” means that the thermal barriers 62 are preassembled (adhered, connected via friction fit, clipped, etc.) and thus physically connected to the top cover 54 to establish a unitary, integrated component. In some implementations, the thermal barriers 62 may be provided as “part in assembly” (PIA) to the sensing cover assembly 44.

The thermal barriers 62 may be made of thermally resistant materials such as mica, aerogels, etc. However, other materials or combinations of materials could be utilized to construct the thermal barriers 62 within the scope of this disclosure.

The top cover 54 may include a plurality of slots 64. The slots 64 may be formed through a material thickness of the top cover 54. Each slot 64 may be sized to receive an integrated tab 66 of one of the thermal barriers 62. The integrated tabs 66 may be securely held within the slots 64 via a friction fit, an adhesive, or other suitable attachment methods in order to integrate the thermal barriers 62 as part of the sensing cover assembly 44. Although not specifically shown, the flexible printed circuit board 56 and the foam barrier 60 may each include corresponding slots that align to the slots 64 of the top cover 54 for accommodating the tabs 66 of the thermal barriers 62.

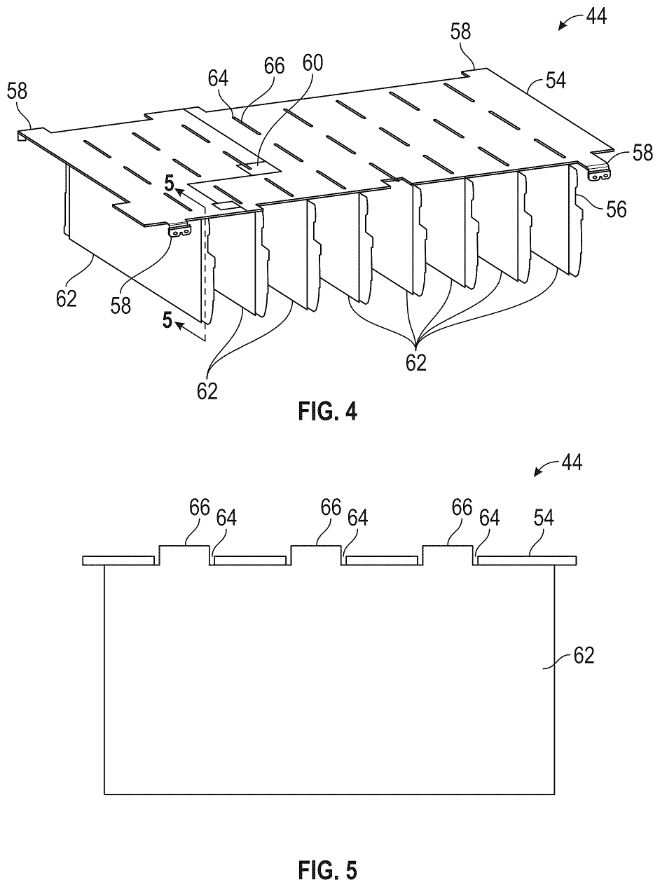

In an embodiment, a plurality of the slots 64 and a plurality of the integrated tabs 66 cooperate to secure each thermal barrier 62 to the top cover 54 (see, e.g., FIGS. 4-6). In another embodiment, a single slot 64 and a single integrated tab 66 cooperate to secure each thermal barrier 62 to the top cover 54 (see, e.g., FIG. 7).

The thermal barriers 62 may be utilized as guides for sliding the battery cells 24 into place when assembling the cell stack assembly 28. The thermal barriers 62 function to hold the battery cells 24 in a vertical orientation prior to insertion of the cell stack assembly 28 into the bottom cover 32 during the battery array 22 assembly process.

In the assembled state of the battery array 22, the thermal barriers 62 may compartmentalize the battery array 22 into two or more groupings or compartments of the battery cells 24. In an embodiment, groups of four individual battery cells 24 are separated by the thermal barriers 62. However, other configurations are contemplated within the scope of this disclosure. Should, for example, a battery thermal event occur in one or more of the battery cells 24, the thermal barriers 62 may reduce or even prevent thermal energy associated with the thermal event from moving from cell-to-cell across the length of the battery array 22, thereby inhibiting the transfer of thermal energy inside the traction battery pack 18.

The exemplary battery arrays of this disclosure include thermal barrier integrated sensing cover assemblies for electrically connecting a stacked grouping of battery cells. The thermal barriers and top cover of the integrated sensing cover assembly are integrated together to reduce parts, simplify logistics, optimize array packaging and efficiency, and provide increased energy density, among other benefits.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a plurality of battery cells; and
a busbar module assembly configured to electrically connect the plurality of battery cells, the busbar module assembly including a first busbar module, a second busbar module, and a cover assembly connected to the first busbar module and the second busbar module,
wherein the cover assembly includes a plurality of integrated thermal barriers.

2. The battery array as recited in claim 1, wherein the plurality of integrated thermal barriers are secured to a top cover of the cover assembly.

3. The battery array as recited in claim 2, wherein the cover assembly is a sensing cover assembly that further includes a flexible printed circuit board.

4. The battery array as recited in claim 3, wherein the sensing cover assembly includes a foam barrier disposed between the top cover and the flexible printed circuit board of the sensing cover assembly.

5. The battery array as recited in claim 2, wherein a first thermal barrier of the plurality of integrated thermal barriers includes a tab received within a slot of the top cover to secure the first thermal barrier to the top cover.

6. The battery array as recited in claim 2, wherein a first thermal barrier of the plurality of integrated thermal barriers includes a plurality of tabs received within a plurality of slots of the top cover to secure the first thermal barrier to the top cover.

7. The battery array as recited in claim 2, wherein the plurality of integrated thermal barriers are comprised of a thermally resistant material, and the top cover is comprised of a plastic material.

8. The battery array as recited in claim 1, wherein a top cover of the cover assembly includes a first mount received through a first opening of the first busbar module, and a second mount received through a second opening of the second busbar module.

9. The battery array as recited in claim 1, wherein a frame of each of the first busbar module and the second busbar module includes an opening sized to receive a cell tab terminal of at least one battery cell of the plurality of battery cells.

10. The battery array as recited in claim 9, comprising a busbar mounted to the frame.

11. A battery array for a traction battery pack, comprising:
a cell stack assembly including plurality of battery cells and a busbar module assembly, wherein the busbar module assembly includes a cover assembly comprising a top cover and a first thermal barrier secured to the top cover.

12. The battery array as recited in claim 11, wherein the cover assembly is a sensing cover assembly that further includes a flexible printed circuit board.

13. The battery array as recited in claim 12, wherein the sensing cover assembly includes a foam barrier disposed between the top cover and the flexible printed circuit board.

14. The battery array as recited in claim 11, wherein the cover assembly is connected to a first busbar module and a second busbar module of the busbar module assembly.

15. The battery array as recited in claim 14, wherein the top cover of the cover assembly includes a first mount received through a first opening of the first busbar module, and a second mount received through a second opening of the second busbar module.

16. The battery array as recited in claim 11, wherein the first thermal barrier includes a first tab received within a first slot of the top cover to secure the first thermal barrier to the top cover.

17. The battery array as recited in claim 16, wherein a second thermal barrier of the sensing cover assembly includes a second tab received within a second slot of the top cover to secure the second thermal barrier to the top cover.

18. The battery array as recited in claim 17, wherein a third thermal barrier of the cover assembly includes a third tab received within a third slot of the top cover to secure the third thermal barrier to the top cover.

19. The battery array as recited in claim 11, wherein the first thermal barrier of the cover assembly includes a plurality of tabs received within a plurality of slots of the top cover to secure the first thermal barrier to the top cover.

20. The battery array as recited in claim 11, wherein the first thermal barrier is comprised of a thermally resistant material, and the top cover is comprised of a plastic material.
